(19) United States
(12) Patent Application Publication
(10) Pub. No.: US 2005/0021396 A1
(43) Pub. Date: Jan. 27, 2005

(54) Method of assessing the cost effectiveness of advertising

(75) Inventors: Andy Pearch, London (GB); John Billett, London (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: BCMG Limited, London (GB)

(21) Appl. No.: 10/625,655

(22) Filed: Jul. 24, 2003

(51) Int. Cl. G06F 17/60

(52) U.S. Cl. 705/14

(57) ABSTRACT

An apparatus for assessing the cost effectiveness of an advertising campaign includes an input for receiving a first set of data from at least one first data source and a second set of data from at least one second data source, an output, and a processor arranged to aggregate and analyse the first set of data using at least one metric in order to provide output data, each of the at least one metric assessing a different characteristic of the first set of data. The processor also calculates a quality score according to a first scoring algorithm applied to the output data; calculate a cost premium from the second set of data according to a second scoring algorithm; and transmits to the output a graphical and quantitative comparison of the cost premium and the quality score, the cost premium being relative to a cost benchmark and the quality score being relative to a quality benchmark.

The present invention relates to an apparatus, a method and a system for assessing the cost effectiveness of advertising.

Assessing the cost effectiveness of advertising is an important activity for advertisers, and their advertising agents, for them to determine the value for money of an advertising campaign particularly in relation to the advertising campaigns of their competitors, as well as the market in general. The assessment also assists the advertiser to develop an advertising strategy for future campaigns. However, for an advertiser fully to assess the cost effectiveness of a specific advertising campaign, the advertiser has to review, process and evaluate vast amounts of data. Further, that data, for advertising media such as television, is produced very quickly, is fast changing and is, consequently, difficult to ascertain accurately as that data is highly dependent upon the program ratings, audience numbers and the audience type for each channel. Thus, any system, method or apparatus which assists the advertiser in comparing the cost effectiveness of an advertising campaign with the campaigns of other advertisers and of his competitors, in terms of quality, cost, and effectiveness in reaching a target audience would greatly assist that advertiser in quantitatively evaluating the campaign. That assistance is more advantageous where the advertiser is provided with a summary of the assessment, enabling the advertiser to respond quickly to the assessment by altering the campaign strategy within the strict constraints imposed by the commercial environment of the television industry.

As is known, panels are used to sample television audiences. The panel members are randomly selected from the public such that the panel is a representative sample of the audience in the relevant territory. One system that exists in the United States is known as the Nielsen People Meter. Each panel member is provided with a set top box. The set top box is operated by the panel member when watching TV to indicate the channel he is watching. Each set top box intermittently uploads data comprising the viewing history of the corresponding panel member to the operator of the panel. The operator can process all the data collected from all the set top boxes to estimate with relative accuracy the audience size for each television channel at a particular time, and how the audience size changes for that channel over time.

Further, another database provides information about the programing schedule of each channel. As certain audience types are more likely to watch some programs than others, this database helps to determine the types of audience likely to be watching each of those channels at a specific part, or time, of day (herein after known as a daypart), and how the audience type viewing a particular channel is likely to change over time. By combining those two databases, the advertiser can assess when his target audience is most likely to watch a certain TV channel and the likely size of that audience. However, this evaluation fails to assess the advertiser's campaign against a market standard, and the campaigns of his competitors. Furthermore, it is impractical for the advertiser to assess its campaigns, whether on broadcast network TV, cable TV or syndicated TV, all the time. There are two reasons for this: advertisers do not have access to this type of data, as it is not market practice for them to buy it; and they do not have the systems and arrangements to process the large amount of data required to obtain reliable results. Also, advertisers generally do not appreciate the meaning of the data and cannot manipulate it to obtain a practical analysis of the data. Therefore, the combination of those two databases by an advertiser could not in itself provide an accurate benchmarks of cost and quality with which to compare the campaign.

Data from a database which comprises cost information for the advertising slots for given audiences and dayparts in a programming schedule of all channels is available in some territories. In the United States, SQAD specializes in providing advertising market costings. SQAD operates a network TV costings system and a database: Netcosts, which is a source of this sort of data. From the data on Netcosts, an advertiser can compare the cost of his own particular campaign with the cost for other advertising campaigns including those of the advertiser's competitors—an advertiser, obviously, knows his costs, but he does not know the corresponding cost for other market participants. Although there are various methods, systems and apparatus which achieve the objective of Netcosts it is impractical for an advertiser to assess the cost of its advertising campaign relative to its competitors, and the market in general, by considering each advertising slot on each and every TV channel and the cost relative to quality obtained for the advertiser, its competitors and the market in general. Further, the average cost and quality the advertiser's campaign is not determined and those values are not compared to benchmarks of cost and quality of the market as a whole.

An aim of this invention is to provide an improved method for assessing the cost effectiveness of an advertising campaign.

In this specification a campaign is a period of advertising activity designed to achieve a specific objective. A distributor is the company, or network, that transmits the adverts. A score is a measure of advertising quality expressed out of 100. A premium is a measure of difference, relative to a normal value. In the embodiments, this is expressed by percentage point increase, or decrease, relative to the normal value. A benchmark is a set of scores, or premiums, aggregated to give an average score, or average premium, respectively, that can be expected. A cost premium is a quantitative value calculated by comparing the costs for the advertising campaign with the average costs of selected advertising campaigns operated by at least one other party. A metric is a mathematical algorithm that generates a score by evaluating an element of the client's campaign to a given comparative. In the embodiments, the score is out of 100. A quality score is a quantitative value calculated by way of the application of at least one metric applied to data obtained from an advertising campaign and some data from selected advertising campaigns operated by at least one other party. A rating is the percentage of the available audience that make up the viewing at a particular time. A spot is a single transmission of an advert.

The present invention provides apparatus arranged for assessing the cost effectiveness of an advertising campaign, the apparatus comprising: a) an input for receiving: i) a first set of data from at least one first data source; and ii) a second set of data from at least one second data source; b) an output; and c) a processor arranged to: i) aggregate and analyse the first set of data using at least one metric in order to provide output data, each of said at least one metric assessing a different characteristic of the first set of data; ii) calculate a quality score according to a first scoring algorithm applied to the output data; iii) calculate a cost premium from the second set of data according to a second scoring algorithm; and iv) transmit to the output a graphical and quantitative comparison of the cost premium and the quality score, the cost premium being relative to a cost benchmark and the quality score being relative to a quality benchmark. In the preferred embodiment the first set of data comprises information concerning different features of the advertising campaign which relate to the quality of that advertising campaign. Further, the second set of data comprises financial information concerning that advertising campaign including, but not limited to, each cost of the advertising campaign.

Advantageously, an advertiser can evaluate an advertising campaign relative to the market standards, and his or her competitors, in terms of quality and bought cost, each as a quantitative score and premium, respectively, and further, can graphically and quantitatively compare the score and the premium to assess the cost effectiveness of that campaign versus the benchmarks of the market.

According to a second aspect of the invention there is provided a method for assessing the cost effectiveness of an advertising campaign, the method comprising the steps of: a) receiving a first set of data from at least one first data source; b) processing the first set of data to provide output data by aggregating and analysing the data by means of at least one metric, said at least one metric assessing a different characteristic of the first set of data; c) processing the output data according to a first scoring algorithm to calculate a quality score; d) receiving a second set of data from at least one second data source; e) processing the second set of data according to a second scoring algorithm to calculate a cost premium; and f) graphically outputting an image showing a quantitative comparison of the cost premium and the quality score, the cost premium being relative to a cost benchmark, and the quality score being relative to a quality benchmark. In the preferred embodiment the first set of data comprises information concerning different features of the advertising campaign which relate to the quality of that advertising campaign. Further, the second set of data comprises financial information concerning the advertising campaign including, but not limited to, each cost of the advertising campaign.

An embodiment of the invention for use in assessing the cost effectiveness of an advertising campaign is now described by way of example only with reference to the following drawings, in which:

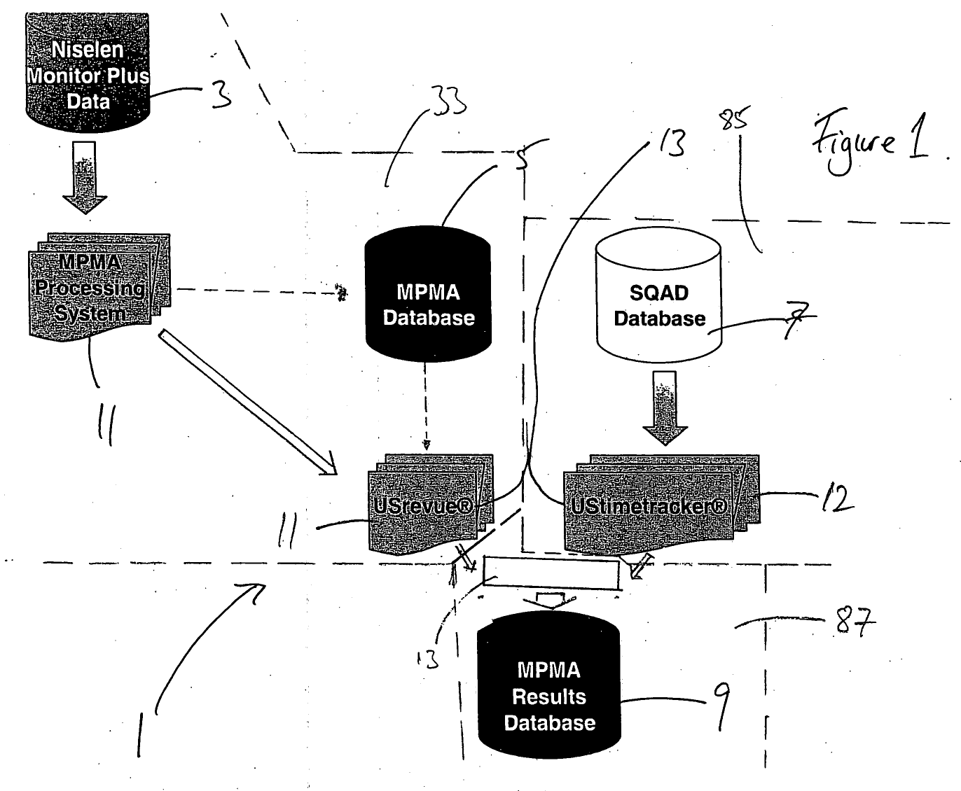

FIG. 1 is a schematic representation showing the important components of a system used to process the data, starting from the source databases and ending with an advertiser's database;

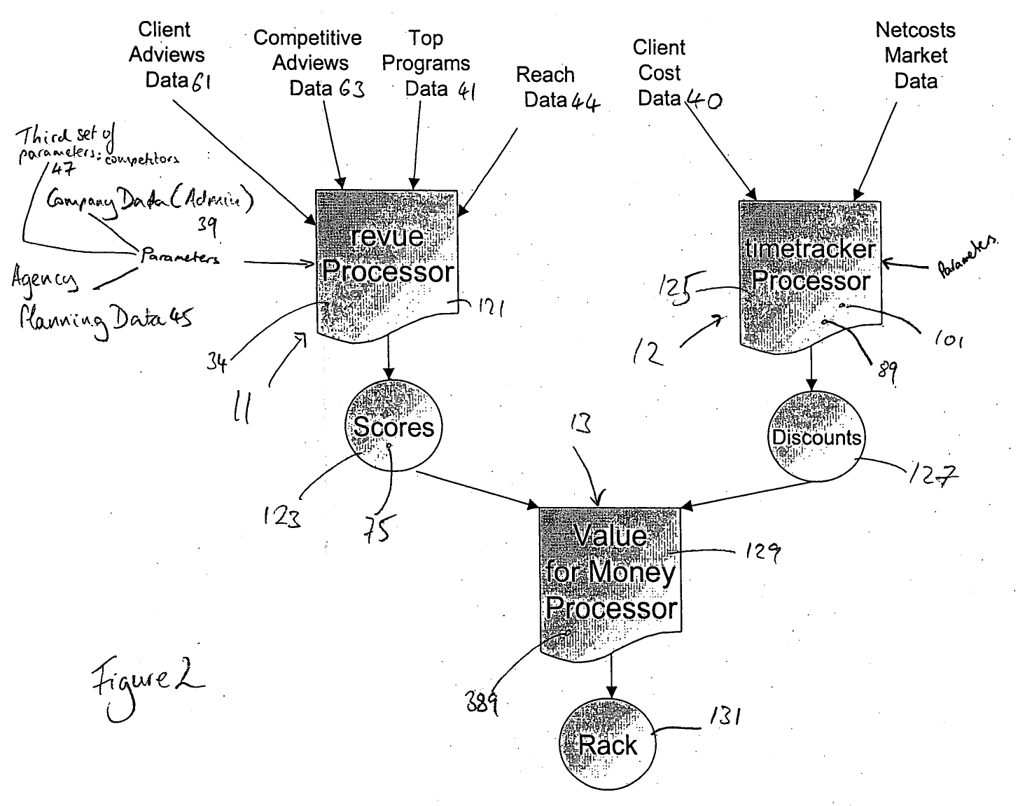

FIG. 2 is a schematic representation of various routines used in the system, and the interrelationships of those routines;

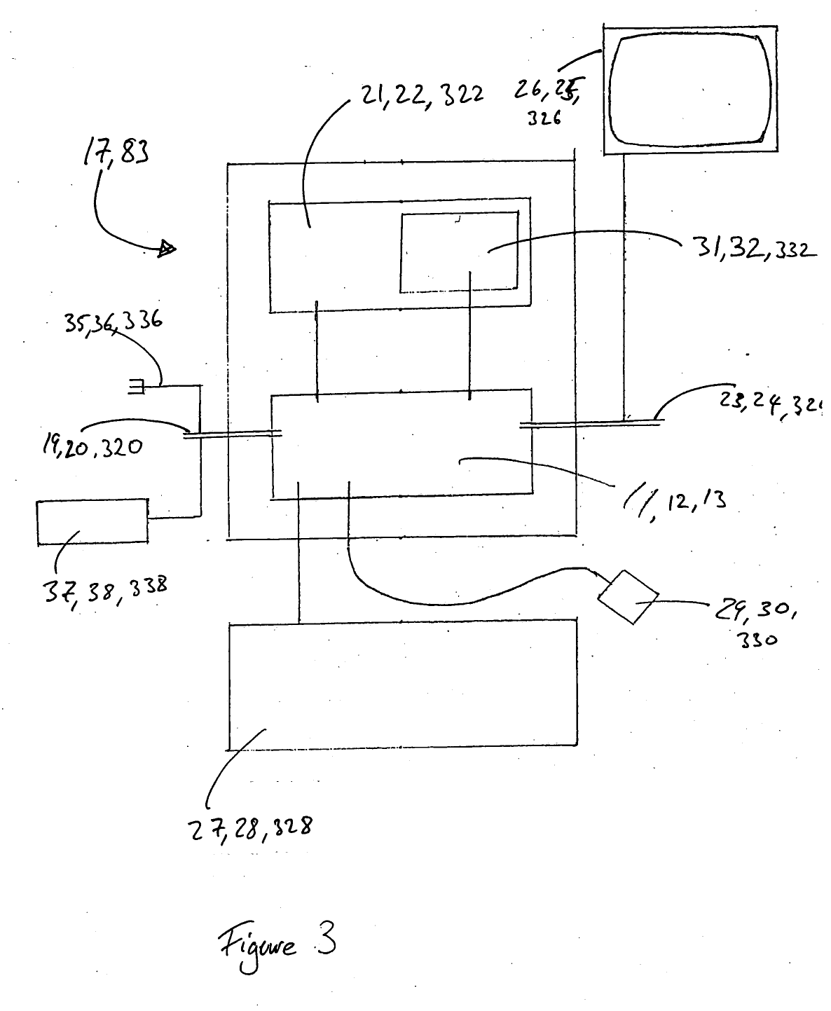

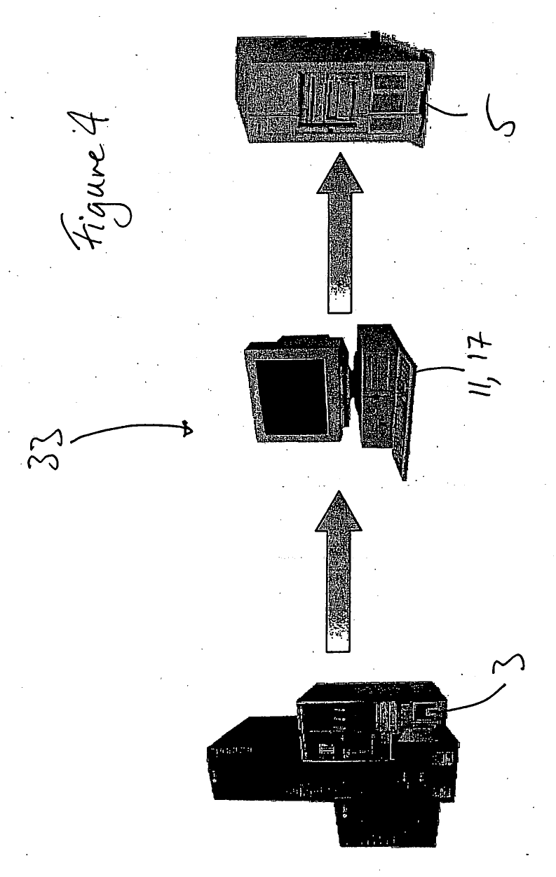

FIG. 3 is a schematic block representation of a computer comprising a processing unit that is used in a system made according to the invention;
-FIG. 4 is a schematic representation showing the stages of processing of the Neilson Adviews data;

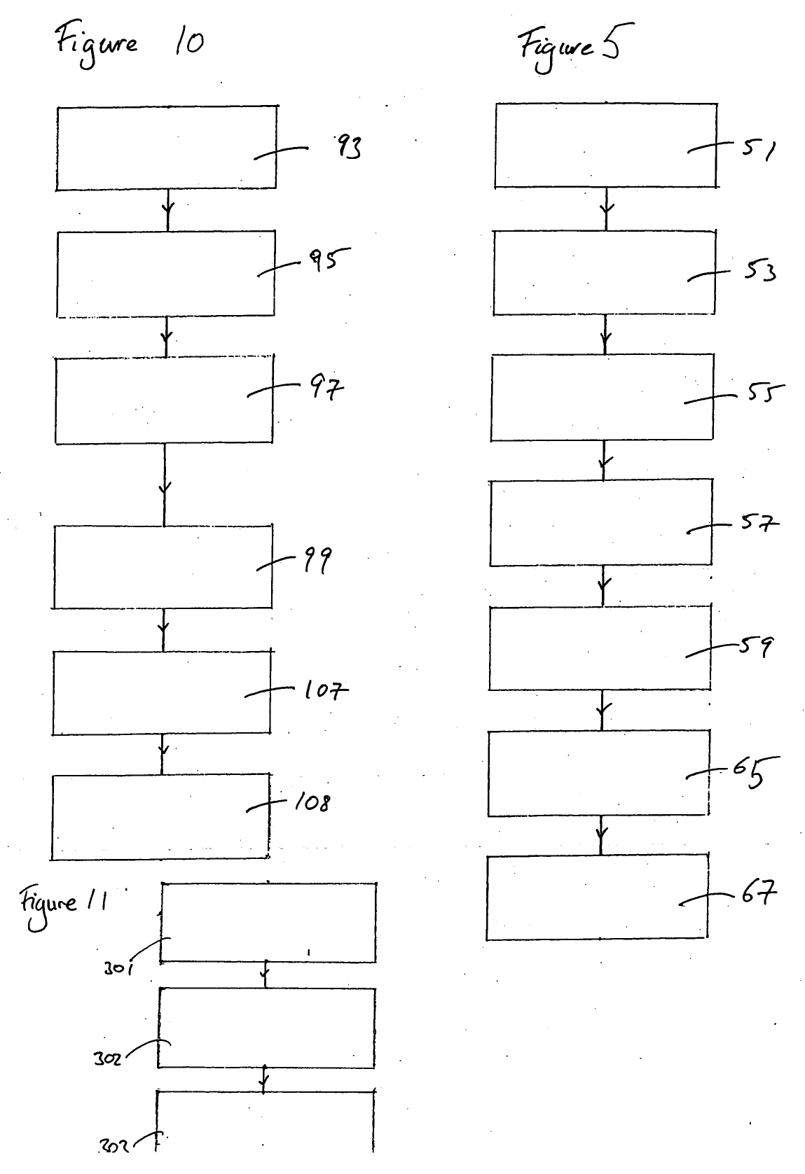

FIG. 5 is a flow diagram showing the steps carried out by a first processing unit;

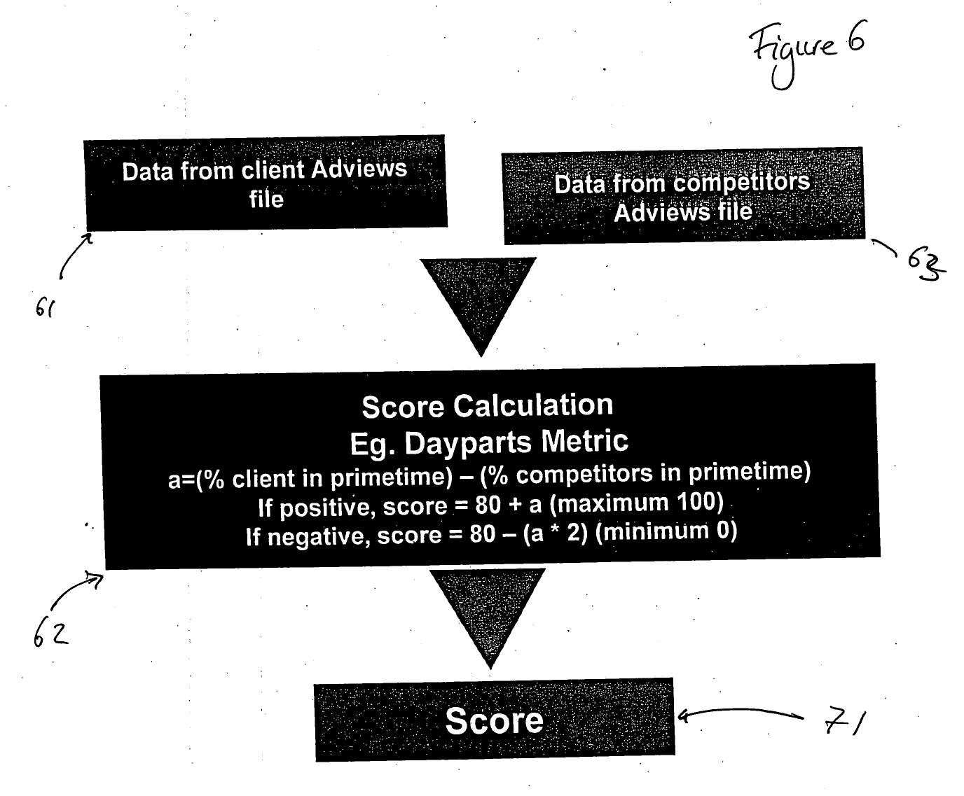

FIG. 6 is a flow diagram showing the steps carried out in a metric;

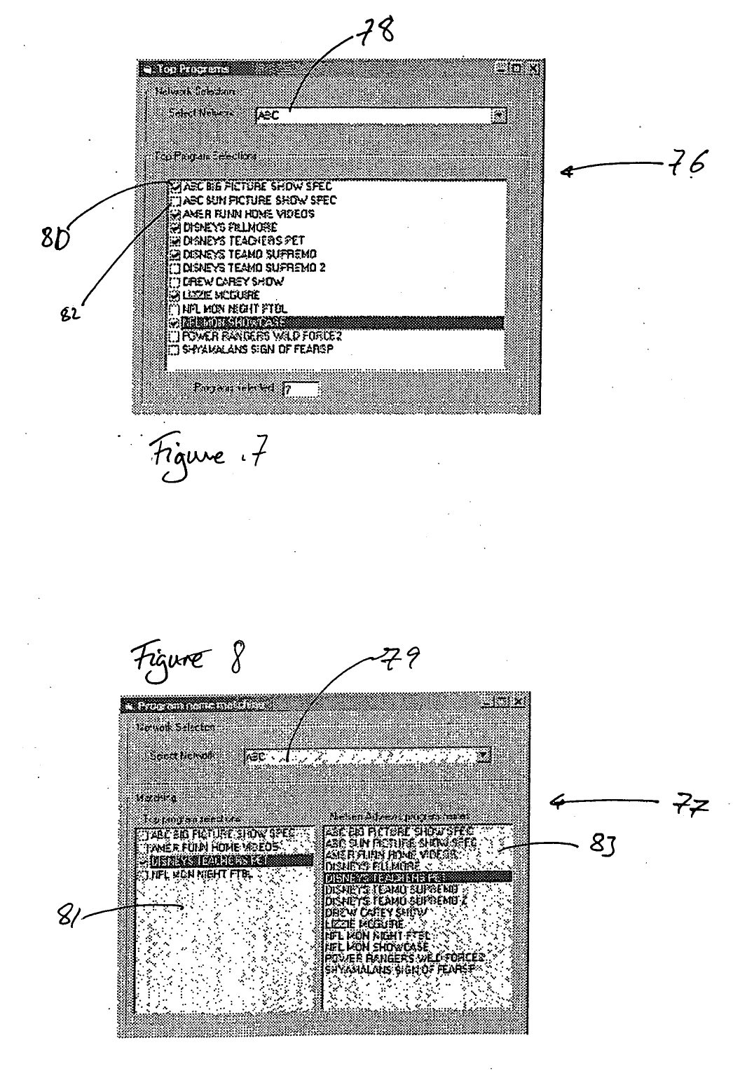

FIG. 7 shows a screen window suitable for an operator to select programs from a list;

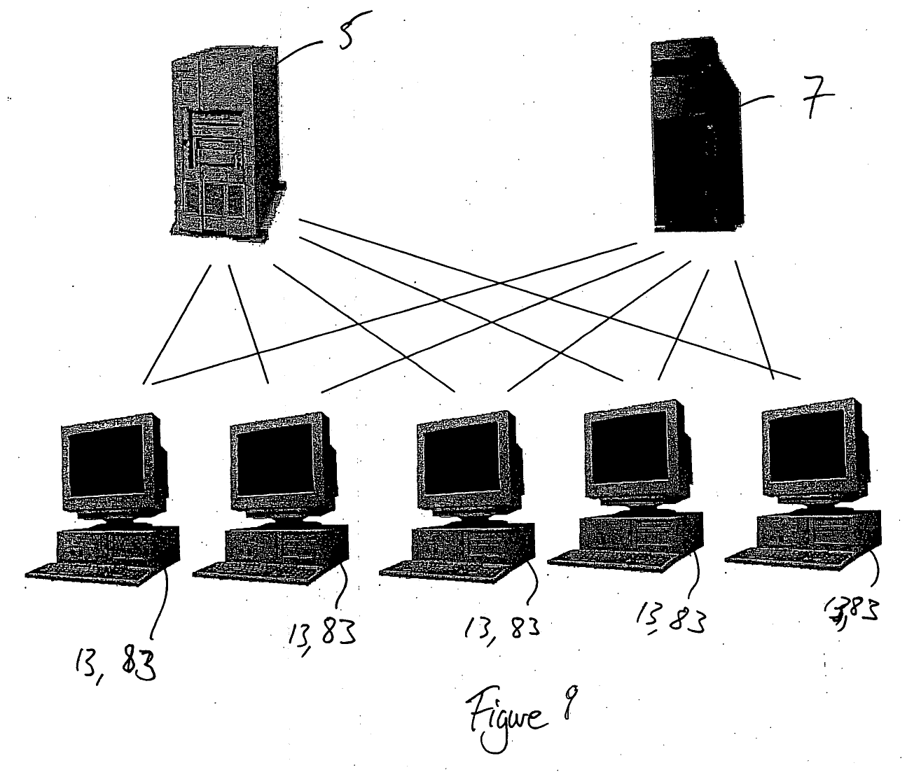

FIG. 8 shows a screen window suitable for an operator manually to match selected programs from the top programs file with the programs in the Nielsen Adviews data;

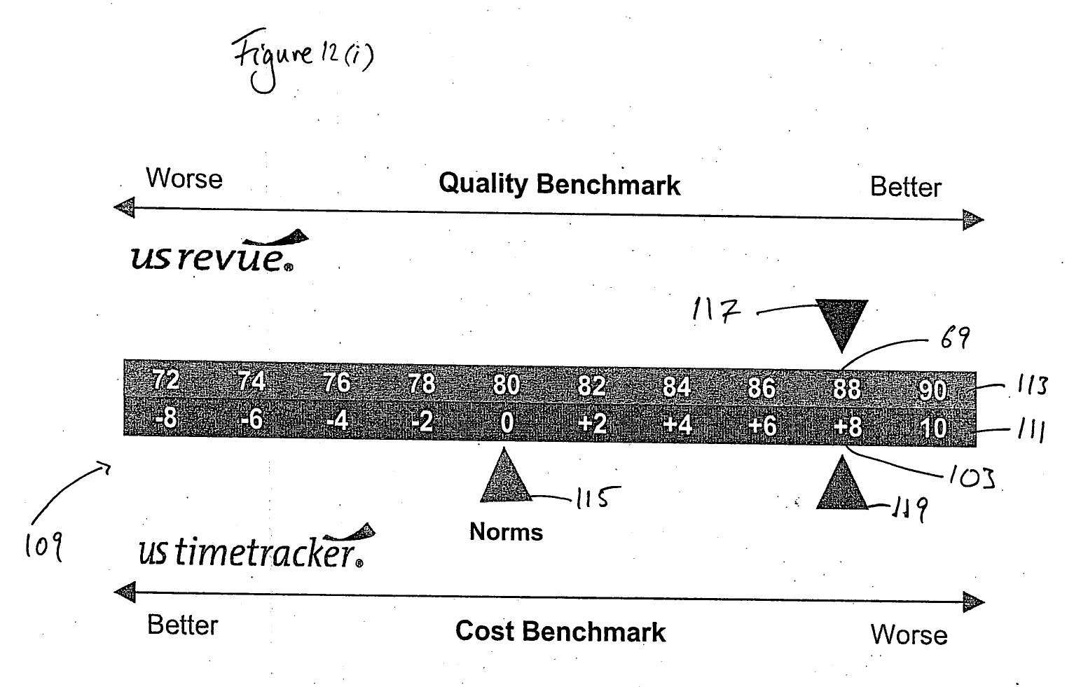

FIG. 9 is a schematic representation showing the system local to a computer comprising a second processing unit;

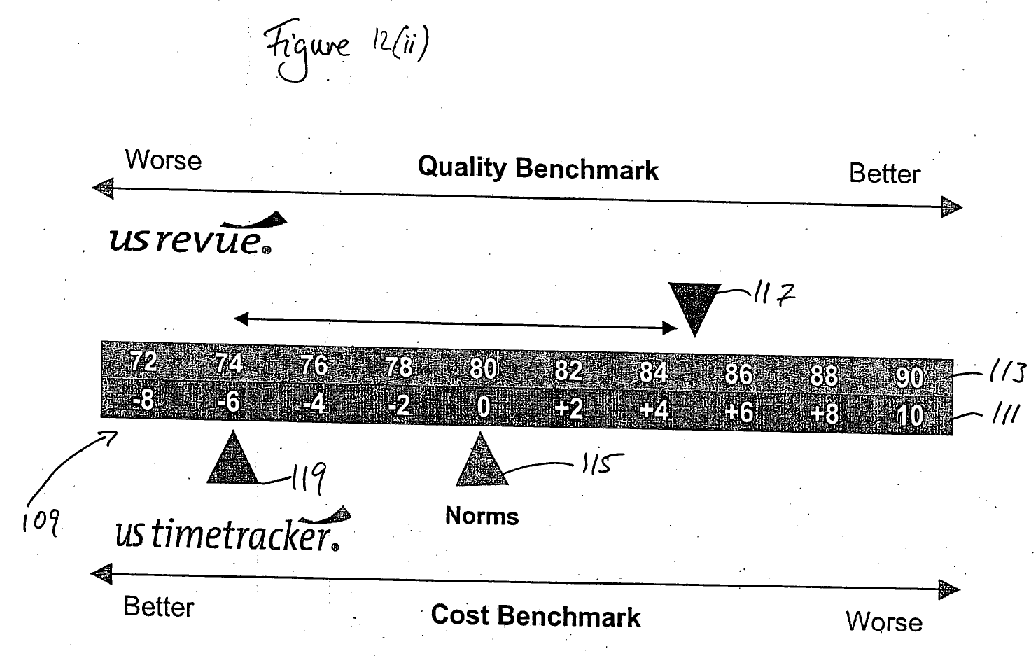

FIG. 10 is a flow diagram showing the steps carried out by a second processing unit;

FIG. 11 is a flow diagram showing the steps carried out by a third processing unit; and

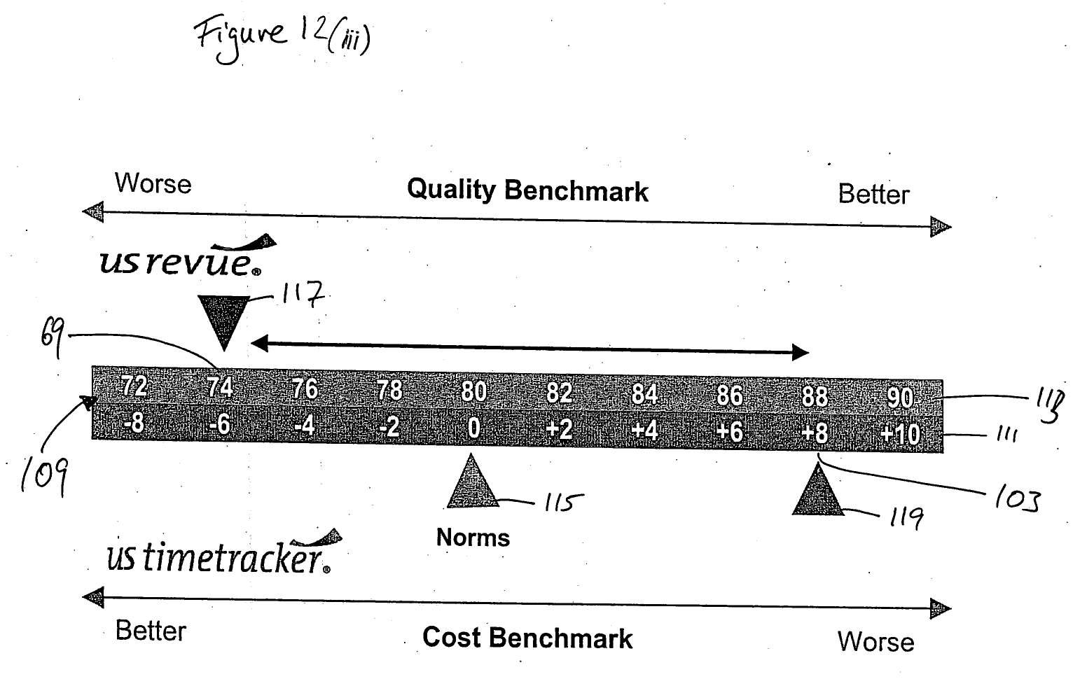

FIG. 12 is a representation of a value-for-money spectrum demonstrating three types of performance:
i) equitable performance;
ii) excellent performance; and
iii) poor performance;

Referring to the drawings, FIG. 1 shows a preferred embodiment of a system 1 for assessing the cost effectiveness of the advertising campaign. The various components of that system 1 are: a first database 3, a second database 5, a third database 7, a fourth database 9, a first processing unit 11, a second processing unit 12 and a third processing unit 13. The first database 3, also known as “the Nielsen Monitor Plus Database” which provides “the Nielsen Adviews” data, is connected to the first processing unit 11 to which the first database 3 transmits a data signal comprising data from that database. Nielsen Monitor Plus is a system that provides viewing data for various media in the US. Nielsen Adviews is the system used by Nielsen Media Research for delivering Monitor Plus data. The first processing unit 11, also known as the MPMA Processing System, is connected to the second database 5, also known as the MPMA Database, to which the first processing unit 11 transmits an output signal. MPMA is Media Performance Monitor America, which is a service that evaluates the effectiveness of marketing media. As the second database 11 is connected to the first processing unit it can pass information back to the first processing unit. The first processing unit 12 receives, on request, a return signal comprising data from the second database 5. The first processing unit 11 processes the data comprised in the data signal to provide an output. The third database 7, also known as Netcosts, is connected to the second processing unit 12 from which the second processing unit 12 receives, on request, a Netcosts signal comprising data from the second database 5. The second processing unit 12 processes the data comprised in the Netcosts signal to calculate a cost output. The first and second processing units 11, 12 are both connected to the third processing unit 13 and the fourth database 9. The first processing unit 11 transmits the output signal comprising the output, and second processing unit transmits a cost signal comprising the cost output, to the third processing unit 13 and the fourth database 9. The third processing unit 13 processes the two signals to provide a result. The third processing unit is connected to the fourth database 9. The third processing unit 13 transmits a result signal comprising the result where the result is stored as an electronic file.

Each of the three processing units 11, 12, 13 carries out at least one of the routines shown in FIG. 2. A first routine 121, that is carried out by the first processing unit 11, a revue processor, calculates output results for a number of metrics. The first processing unit 11 also operates a second routine 123, where the output results are converted into a metric score by a qualitative algorithm. Together the first and second routine comprise a computer program that is known as USrevue. Usrevue is designed to evaluate the media campaign performance against the key positional and communication objectives of the advertiser, as a score out of 100. It measures how well the advertiser achieved its objectives and whether the campaign reached its optimum visibility in the market on the basis of a selection of competitor campaigns. It further assesses quality parameters and derives an aggregate quality score. The scores are tracked over time, allowing the advertiser to have a clear agenda for continuous improvement.

The second processing unit 12 carries out a third routine 125, the time tracker process, and a fourth routine 127, a discount calculation process. Together those two routines are a computer program known as UStimetraker which assesses the cost of a campaign relative to normal market costs and, therefore, the cost efficiency of media buying by the advertiser.

The third processing unit 13 carries out a fifth routine 129 comprising a subroutine 131. The fifth routine 129, also known as the value for money process, comprises a Value for Money Processor and integrates the results of the cost and quality programs into an overall assessment of the media value which can be displayed by the subroutine in a graphical representation, known here as the rack. This system overlays the range of the quality score of the advertiser with the cost scores of the advertiser. It allows each client advertiser to see how well their campaign fared against other clients of the system operator (MPMA) on average, and also indicates the trade-off available in the market between price and quality. Mathematically, fifty percent of the system operator's clients score below average, ensuring that a significant group of advertisers keeps pushing for better value, driving the agendas of the systems operator in advance of the market average.

The first processing unit 11 is comprised within a first computer 17 as shown in FIG. 3. The first processing unit 11 comprises, together with the first database 3, the second database 5 and the first computer 17, a quality sub-system 33 of the system 1 as shown in FIG. 4. The first computer 17 further comprises an input port 19, a memory 21, an output 23, a screen 25, a keyboard 27 and a mouse 29. The memory 21 is suited for buffering data as it comprises a buffer memory 31 that is connected directly to the first processing unit 11.

The components of the first computer 17 are arranged together such that a signal received by the input port 19 is directed to the processing unit 11 where the signal is processed. The data retrieved from the signal is stored in the memory 21, or is buffered in the buffer memory 31, as required, before transmission from the output 23 to the second database 5. The data is only transmitted from the first database 3 upon receipt by the first database of a request, in the form of a signal for specific data from the processing unit 11. Therefore, for data to be transmitted to the input port 19, the first processing unit 11 transmits a signal to the first database 3 requesting specific data. The first database 3 responds by transmitting a signal to the input port 19, the signal comprising the requested data.

The first processing unit 11 is connected to the memory 21 as well as the buffer memory 31. The memory 21 stores the computer program, USrevue, 34 that controls the first processing unit 11 to process the signal. When USrevue 34 is operated by the first processing unit 11, the first processing unit carries out the steps shown in the flow diagram of FIG. 4, which will be described later in the specification. Attached to the input port 19 are an Internet connection 35 and a device such as a CD ROM reader 37 that is capable of reading computer readable media. It should be appreciated that FIG. 3 is schematic and not to scale, and that some features are actually comprised of several components, such as the input port 19 which comprises several separate input ports.

The mouse 29, the screen 25, the keyboard 27 and the first processing unit 11 are configured to enable an operator of the first computer 17 to enter a set of parameters manually for recordal in the memory 21 as an electronic file. Alternatively, a set of parameters can be provided in the form of an electronic file which is received at the input port 19 the file being encoded in a signal that is extracted for storage on the memory 21 by the processing unit 11. Where a set of parameters is provided as an electronic file, the encoding signal is transmitted via the Internet connection 35, or is provided from a CD ROM read by the CD ROM reader 37. Further, some parameters of a set can be manually entered and the remaining parameters of that set transmitted to the computer in an electronic file.

In the preferred embodiment there are a number of sets of parameters and input data. A first set of parameters 39 is the Campaign Data (Administration). This set includes, but is not limited to: a name of the client, a brand, a campaign start date, a campaign end date, a campaign title and a target audience. The set further comprises details of the daypart scheme applicable to the campaign. Normally a standard daypart scheme is used, but optionally the definition of the daypart scheme can be included in this first set of parameters where that daypart scheme varies from its standard definition. The daypart scheme can be defined specifically to a campaign or a client. Where the daypart scheme has been defined, the same definition of the daypart scheme is used to process the data of the competitors.

A first set of input data is a data file provided by SQAD detailing the top ranking programs for each. TV channel during the campaign period. The data is substantial in amount and is detailed. To avoid manual entry errors, the data is provided as an electronic file, known as the a top programs file 41.

A second set of input data is a reach file 44, provided as an electronic file. Reach data, that is comprised in the reach file, indicates the number of homes to which the advert was actually broadcast. A reach file 44 is an evaluation of the campaign by channel which indicates the percentage of a specified audience has seen the advertisement, and the advertising message, over a given period. The reach file shows how this percentage has cumulatively grown over the duration of the campaign by showing the percentage value at specific increasing rate intervals.

A second set of parameters 45 is the agency's planning data which comprises the prospective, and projected, ratings of the client for the brand for each week of the campaign.

A third set of parameters 47 comprises the name of one or more competitors, and their respective brands, against whose campaigns the client's campaign will be assessed. The competitors are identified and selected by the client, his advertising agency, and the operator of the system, such as MPMA. The competitors may be competitors for air time rather than brand competitors. Therefore, whether the competitive set is comprised of competitors for airtime, or as brand competitors, is at the client's discretion. If the client chooses to have a direct comparison with the market as a whole, he will chose a number of competitors that compete for the same airtime as the campaign. The third set of parameters 47 is either typed in manually, or is supplied in the form of an electronic file. Together the campaigns of the competitors are referred to as the competitive set.

A fourth set parameters indicates the location of data files on the first database 3, the data files comprising the data to be assessed. The parameters of this fourth set are the names of the client and the selected competitors from the first set of parameters 39 and the third set of parameters that have been automatically collated into this fourth set of parameters. These parameters are used by the system to locate each spot data file in the first database that corresponds to the client, client Adviews data 61, or one of the members of the competitive set, competitive Adviews data 63.

Each set of parameters is stored in a file in the memory 21 as a data file, all the data files being stored in one folder.

FIG. 5 shows the steps of the process carried out in the processing unit 11 in the quality sub-system 33. It has two phases, a revue process, also known as the first routine 121 which sources and validates the data, and a scoring process, also known as the third routine 125, which applies the metrics to the data. A first step 51 begins the revue processor. In the first step 51, the sets of data and the sets of parameters are entered into the first computer 17 manually, or electronically, for storage in the memory 21.

In a second step 53, the first processing unit 11 transmits to the first database 3, a signal requesting that the first database transmit to the first computer 17 those files on that database 3 that correspond to the campaign and the competitive set in the period of the campaign to be assessed. Those files that comprise data about the campaign are known as campaign spot data files 61; and those files that comprise data about the competitive set are referred to as competitor spot data files 63. Each spot data file 61, 63 refers to each spot or each time an advert is aired on each TV channel; and each spot data file 61, 63 comprises details describing the characteristics of the associated spot.

In a third step 55, as the data files comprising the data are validated to ensure that they all exist before the data is received by the first processing unit 11 from the first database 3. Further, each campaign spot data file 61, and each competitor spot data file 63, is validated to ensure each of the data fields of each spot data file is in the correct format and each spot data file comprises the correct number of fields. This process includes the steps of checking that:
1. the spot type is a valid venue, where a venue is a type of network TV advertising—broadcast, cable or syndication;
2. the date when the spot was transmitted is a valid date, and that that date falls within the campaign period;
3. the time at which the transmission of the spot begins is in 24 hour format;
4. the distributor is one of the known networks;
5. the duration of the spot is in units of seconds;
6. the position of the spot in a POD, where a POD is a description of the position of an advertising break during a TV program—e.g. the second break in a program would be the second POD of that program and this data is in the following format: firstly, a POD number, secondly, a colon, and finally the position of the spot in the POD;
7. the spot program (the program transmitted closest in time to the spot time) is a string, being in alphanumeric code; and
8. the spot rating (the audience size) and the spot impact (the number of people viewing a single transmission of an advert) are both numbers.

Where a spot date occurs before the beginning of the campaign start date, a warning is generated and directed to an operator of the system. The warning sent to the operator is an error file directed towards the screen 25 for visually displaying to the operator and towards the first processing unit to stop that unit from operating.

Once each campaign spot data file 61, and each competitor spot data file 63, has been validated, each spot data file has a daypart assigned to that spot data file. The spot time field of each spot data file 61, 63 is used to determine the daypart number for that spot by comparing the spot time of a data file with the daypart scheme definition for that campaign. The daypart is then assigned as a further field for the corresponding spot in the relevant spot data file. The spot data file 61, 63 then is stored in the memory 21.

In a fourth step 57, the reach file 44 and the top programs file 41 file are validated to ensure that they exist and that they are in the correct format. The reach file 44 is validated by ensuring that each ratings value is a number that is greater or equal to zero, and that the reach percentage is a number that is greater or equal to zero and less than or equal to one hundred. The top programs file 41 is validated by checking that each distributor referred to is a known network, the program name is a string of alphanumeric characters and that each ratings value is a number that is greater or equal to zero.

In a fifth step 59, the data of each spot data file 61, 63 is aggregated for use with a scoring algorithm 75 in the scoring process 125 to determine a quality score 69. In the aggregation, the spot data files 61, 63 are assessed using the nine different metrics. All nine of those metrics are normally used. However, all of the metrics are optional and the client can select those metrics which he would like to use and that bests suit his campaign. Some metrics may not suit particular campaigns as those metrics value features which are irrelevant for a particular campaign. For example a metric which values evening daypart is very likely to be unsuited to a campaign for children's toys.

Each metric has at least one output result 71 which is buffered in the buffer memory 31. Each output result 71 is a numerical metric score in the range of zero to one hundred, inclusive. The metrics are applied to the campaign spot data files 61 and to the competitor spot data files 63. If a metric is applied to both the campaign and the competitive set the output result from that metric is considered as an output result of the campaign. The output results 71 from each metric for each of the campaign and the competitor data files 61, 63 are kept separate where that metric is not applied to both the campaign and the competitive set. If that metric is independently applied to the competitive set and the campaign, each of the output results from the application of that metric to each of member of the competitive set are pooled together. It should be noted that the competitor spot data files 63 will be over the same period as the campaign and will, therefore, contain data that corresponds to partial campaigns of the various competitors, where those campaigns extend beyond the start date and end date of the client's present campaign.

In a sixth step 65, the scoring algorithm 75 is applied to the output results 71 of the campaign to calculate the quality score 69, by a weighted average calculation, where some metrics have greater weighting as they are of greater significance to the advertiser, i.e. the client.

In a seventh step 67, all the results of the algorithm 75, together with a set of summary data for the campaign and a set of summary data for the competitors, are transmitted in a signal from the first processing unit 11, by way of the output port 23, to the second database 5 for storage. The summary data is listed for the campaign in a number of categories. However, a briefer summary is provided for those characteristic numerical values for the competitive set in a category designated for the competitive set. Those categories for the campaign are, in the preferred embodiment: holding companies (which are used to aggregate scores by reference to the parent company of an advertiser); clients; brand; daypart; daypart name; network; campaign data; top programs; venue; metric output results; campaign totals; and audience.

Also, the operator may direct the first processing unit 11 to transmit the summary data for the campaign, including the quality score 69, directly to the third processing unit 13.

The qualitative algorithm 75 is applied to all the output results 71 derived from each metric applied to all the spot data files 61 and 63. The algorithm can be varied to suit the needs of the advertiser. Each metric processes the raw data of each spot data file 61, 63 to provide a characteristic of the campaign in a numerical format: the output results, providing a series of results: an output result for each metric. Each output result is in the range of zero to one hundred inclusive. However, most metrics will only give an output result if the metric is also applied to the aggregated raw data of the competitive set.

Some or all of the metrics are applied to both the campaign and the competitive set. Where a metric is used on the campaign, it should also be used on the competitive set. Therefore, where the metrics described below refer to the application of the metrics on the campaign, they should also be read also to apply on the competitive set.

In the preferred embodiment, there are nine metrics. Each metric assess different characteristics of the features of the spot files. Those metrics assess:

1. The Daypart Mix Versus Averages and Competitive Set

This metric essentially evaluates the percentage of impacts per day part. The subsystem 33 calculates from the campaign and competitive set data files the total number of impacts for the campaign and for the competitive set, respectively, for each daypart and in total. Each impact is a single viewing of an advert by a single person. However some impacts are a number of individual viewings of the advertising message including those that have viewed the advertising message a number of times. The sub-system 33 also counts the total number of spots and, therefore, the total number of impacts in each daypart. The sub-system 33 then calculates the total number of impacts in each daypart as a percentage of the total number of impacts per day.

FIG. 6 is a flow diagram representing this metric: the daypart mix versus averages and competitive set 62. Client Adviews data 61 and competitor Adviews data 63 comprised in the spot data files are fed into the metric 62. The algorithm that comprises the metric is applied to the spot data files to provide a score 71 for use in the scoring algorithm.

2. Campaign Levels Versus By Venue Verus Competitive Set

This is the percentage of impacts by venue. Here the term venue is intended to designate a TV channel. The sub-system 33 determines from the spot data files the total number of impacts for the campaign, the competitive set and for all spots. The sub-system also counts the total number of impacts by venue for the campaign, the competitive set and for all spots. Further, the sub-system 33 calculates the total number of impacts by venue for the campaign and the competitive set as a percentage of a total number of impacts for the campaign and the competitors set, respectively, as well as a percentage of the total number of impacts during the campaign period, as well as for the campaign period and competitive set.

3. Campaign Levels Versus Averages and Competitive Set by Broadcast Network

This metric assesses the percentage of impacts by broadcast network. The sub-system 33 reviews the spot data files 61, 63 and calculates the total number of impacts for network TV as a whole during the campaign, for the campaign and the competitive set during that campaign. The sub-system 33 also determines the network distributor from the distributor field for each spot data file that is spot on a network TV channel in order to count the number of impacts for each network distributor for each of the campaign and competitive set. The output result 71 for this metric is the total number of impacts for each network for each of the campaign and the competitive set expressed as a percentage of the total number of network TV broadcast impacts for each of the campaign and the competitive set, respectively, as well as the total number of network TV impacts.

4. Distribution of Campaign by Daypart and Venue

This metric assesses the distribution of the spots of the campaign by venue and daypart. The sub-system 33 calculates from the spot data files 61, 63 the total number of impacts for each of the campaign and the competitive set. For each of the campaign and the competitive set, the sub-system 33 calculates the number of those impacts in each venue and in each daypart and expresses each of the total number of impacts in each venue and daypart as percentage of the total number of impacts of the campaign or competitive sets, respectively.

5. Weekly Ratings Delivered Against Plan

This metric examines the client's ratings for the campaign by week and evaluates it in relation to the agency's planned ratings by week, also known as the second set of parameters 45. The sub-system 33 reads in the second set of parameters 45 from the memory 21 to the first processing unit 11 and then to the buffer memory 31. The sub-system 33 otherwise reviews the spot data files 61, 63 for the campaign and adds the ratings for each spot to calculate a total ratings for each week of the campaign. Each spot that appears before the start date of the campaign is counted in the first week of the campaign. However, spots falling after the end of the campaign are outside the campaign period and are not assessed by this metric. As the audience is the national audience of a given country for example, the United States, and it is the national audience of the US which is covered by the Adviews Report, the spot ratings can be summarised for the whole of each week from the information provided by Adviews. The variation of the total ratings by week can be expressed as a percentage of the total ratings accrued during the campaign period. Also, the total ratings can be compared to the planned ratings proposed in the second set of parameters 45, which are expressed as the total planned ratings per week. Note that this metric does not compare the campaign against the competitive set, but campaign performance against the predicted performance of the campaign by the agency.

6. Access to Key Programs

This metric examines the top programs file 41 and assesses the percentage of campaign impacts that occurred in each program. The sub-system 33 extracts the top programs file 41 from the memory 21 by means of the first processing unit 11. The first computer 17 is configured to permit the operator to select any number of TV programs in the top programs file for inclusion, or exclusion, in the metric. The top programs file lists the highest rating programmes in the campaign period. Usually the client does not select those programs in the top programs for file associated with spots the advertiser wanted to buy and those he could not buy. As part of the configuration of the first computer, the screen 25 displays in a graphics window 76, shown in FIG. 7, the names of the TV programs contained in the top programs file in descending ratings order for each TV channel. The channel selected is shown in a first network selection box 78. The name of each program is shown in a top programs list 80, where the selection of those programs is indicated by a corresponding checkbox 82 for each program. Before the metric operates, the sub-system 33 ensures that the name of each of the programs in the top programs file 41 matches one of the names program listed in the Nielson Adviews System 3. If the sub-system 33 identifies a mismatch of names, the sub-system 33 carries out a matching process and notifies the operator of any mismatches by a display of a notice on the screen 25, as described below.

In the matching process, the sub-system 33 reviews each of the campaign and competitive set spot data files 61, 63 and generates a list of unique program names for each network and for each cable and syndicated TV station. The operator is then presented on the screen 25 with a list of programs that the operator selected for use with the metric 6: Access to Key Programs. For each of those selected top programs, the operator indicates to the sub-system 33 the corresponding program in the Adviews list using a second graphics window 77, shown on the screen 25 (see FIG. 8). In that diagram, the network is selected in a second network selection box 79, and each program from the programs from the top programs selection list 81 is shown to be matched with a program from the Nielson Adviews Program List 84. The operator has to match every program in the top programs selection list 81. The system stores the data about matching the top program selection list in the memory 21 for transmission by the first processing unit 11 to the second database 5, later in the process.

Once the matching process is complete the sub-system 33 calculates the number of impacts that occur during the transmission of each of the selected programs, using the spot data files of the campaign and the competitive set. Usually, all the programs in which the spots were bought for the campaign are included. The sub-system 33 calculates the total number of impacts in each TV channel for the campaign. The number of impacts bought on each of the specified top programs, for each of the competitive set and the campaign, is expressed as a percentage of the totals for that TV channel, whether Broadcast network TV, cable TV or syndicated TV.

7. Location of POD.

1 This metric assesses the proportion of the campaign was broadcast in the centre as opposed to the end of each POD. The metric is intended to aggregate, by network, the impacts of the campaign that were broadcast in PODs during a program and the number of transmissions of the campaign were broadcast in PODs located at the ends of programs and then express the impacts within PODs in the program period as a percentage of those impacts within PODs at the ends of programs. The percentage is expressed for the whole campaign. The percentage is compared to the similar aggregate percentage for the competitive set. The objective of the metric is to assess the proportion of impacts for a campaign relative to the competitive set that are in a program period as opposed to outside a program period, as the effectiveness of an impact has been found to be greater for an impact a POD during a program than in a POD that is located at the ends of, or between, programs.

8. Position of Campaign Adverts in POD

This metric assesses the percentage of impacts specified in POD positions by network. The metric is intended to aggregate for the campaign and a competitive set, respectively, from the spot data files 61, 63 whether that spot was the first, second, third, or in another position in a POD. The sub-system 33 firstly calculates the total number of impacts for each TV channel for the campaign and the competitive set, respectively. From processing the spot data files 61, 63 for each of the campaign and competitive set, the sub-system 33 calculates the total number of impacts for each POD in the broadcast networks and expresses that figure as percentage of the total number of broadcast network impacts in the campaign period. This percentage calculation is repeated for each TV channel and, thus, for each of the cable TV and syndicated TV stations.

9. Weekly Reach versus Plan

This metric assesses the effective reach of an advertising campaign. The metric is assessed by comparing the percentage reach the campaign achieved relative to the optimum market percentage reach for the bought audience at the level of ratings that the client bought. The percentage reach the client achieved derived from data comprised in the reach file. The optimum market percentage reach for the bought audience at the level of ratings that the client bought is supplied by the client's agent.

The second processing unit 12 is comprised within a second computer 83. The second computer 83 comprises similar components to the first computer 17, shown in FIG. 3: a screen 26, a mouse 30, a memory 22, a buffer memory 32, an output port 24, an input port 20, a keyboard 28, an Internet connection 36, and a CD ROM reader 38. The components are configured to operate in exactly the same way as the first computer 17, except a costings program 89, UStimetraker is comprised in the memory 22 of the second computer 83. This program 89 has a different functionality from the program 34 stored in the memory 21 of the first computer 17. The costings program is arranged to carry out two routines when in operation: the timetraker process 125 and the discount calculation process 127. Further, the second processing unit 12, together with the third database 7, and the second computer 83, comprises a costing sub-system 85, of the system 1. The hardware used in that sub-system is shown in FIG. 9.

In the costing sub-system 85 the second processing unit 12 follows a process as instructed by the costings program 89 stored in the memory 22. That process is set out in FIG. 9. In a first step 93, the client enters the campaign cost data 40, being the advertising costs for the campaign, the networks used for the campaign, the start and end dates of the campaign as well as the dayparts selected for the campaign. The client enters the campaign cost data 40 either manually, or in the form of a prepared electronic file. On receipt of this data by the second processing unit 12, that data is validated by that processing unit. This validation process ensures that all the data is in the required format using a process, the processing having the following steps to check that:
1. the distributor field is a known distributor;
2. the date field (the date on which the spot was transmitted) is valid, and that that month is within the campaign period;
3. the daypart field is in a valid daypart and in an appropriate format; and
4. the market cost value, the cost of one thousand impacts, is a numerical string in US dollars.

In a second step 95 the second processing unit 12 processes the campaign cost data 40 in order to identify the Netcosts data supplied by SQAD that corresponds to the clients costs data. The second processing unit 12 then requests and receives data from the third database 7, that data being market costings data and being comprised within the Netcosts market data files. The data comprised in the files is comprised in a number of fields: daypart; distributor; date; and market cost value.

In a third step 97, as the data is received by the second processing unit 12, that processing unit validates the Netcosts market data files to ensure they all exist and are all in the required format, using a validation process. That process uses the same steps as used to validate the campaign cost data 40.

Where the processing unit finds an error in the data, the validation process stops and the user is alerted of the error in order to remedy that error. Once the error has been remedied, the validation recommences.

In a fourth step 99, the data from the fifth field of the Netcosts market data files, the cost of one thousand impacts, is aggregated by the discount calculation process 127 to provide market cost data, whereby the data from each of the Netcosts data files is aggregated for use with the costings comparator 101—an algorithm which is used to assess a cost premium 103 for the campaign. The costings comparator compares the campaign cost data with market cost data. The data supplied by SQAD from the Netcosts market data files has already been adjusted for factors such as actual and forecast advertising revenue, media space and supply, and market prices for each commercial TV channel. Therefore, the output from comparator accounts for those factors. The main characteristics that the comparator assesses are the client's prices for the campaign, i.e. the data in the campaign cost data, compared with both stretch prices, which are the top and bottom values of a range of prices, and actual paid prices for comparable sport costs corresponding to particular Netcosts datafiles.

In a fifth step 107, the costing comparator is applied to the aggregated data and the client cost data to calculate the cost premium 103 relative to the average market cost.

In a sixth step 108, the cost premium 103 is buffered in the memory 32 before the transmission to the third processing unit 13 as the cost output and to the fourth database 9 for storage. The data that is comprised in the cost output that is stored on the fourth database 9 is kept in storage, with other cost output data, until such time when the system 1 has sufficient cost output data for the pooling of that data with the market cost data for use with the comparator.

The third processing unit 13 is comprised within a third computer 383. The third computer 383 comprises similar components to the first computer 17, shown in FIG. 3: a screen 326, a mouse 330, a memory 322, a buffer memory 332, a output port 324, an input port 320, a keyboard 328, an Internet connection 336 and a CD ROM reader 338. The components are configured to operate in exactly the same way as the first computer 17, except a value for money assessment program 389 is comprised in the memory 322 of the third computer 383. The value for money assessment program 389 has a different functionality from the program 34 stored in the memory 21 of the first computer 17, or the program 89 stored in the memory 22 of the second computer 83. The valve for money assessment program is arranged to carry out one routine when in operation: a value for money process 129 with the subroutine 131 which presents a graphical representation to a screen. That graphical representation is known as the rack 109. Further, the third processing unit, the fourth database 9 and the third computer 383 comprises a value for money subsystem 87 of the system 1 when they are connected to the first processing unit 11 and the second processing unit 12. The hardware used in that sub-system 87 is shown in FIG. 9.

In the value for money sub-system 87, the third processing unit 13 operates according to the value for money assessment program 389 stored in the memory 322 following the steps shown in FIG. 11. In a first step 51, the processor receives from the first processing unit 11 the quality score 69, and from the second processing unit 12 the cost premium 103.

In a second step 302, the third processing unit 13 validates the quality score 69 and the cost premium 103, relative to the data on the memory 322 of the third computer 383. The memory 322 at that time comprises all market data comprised in the system 1, albeit in processed and summarised form. The validation of the quality score 69 and the cost premium 103 ensures that those scores and premiums are accurate compared to all that market data. The third processing unit 13 adjust the score 69 and the premium 103 if those values require correcting.

In a third step 303, the third processing unit 13 transmits a signal to the screen 326. On receipt of that signal, the screen 326 displays a rack 109, as shown in FIG. 12. In the signal is encoded the cost premium 103, the quality score 69, a quality benchmark and a cost benchmark. The quality benchmark is a MPMA norm created using average scores from all the previous campaigns evaluated using the process embodied in US revue 34. It is the same for all clients and sectors. It is initially set at eighty within a range of zero and one hundred, inclusive. Over time this value will increase as the performance of advertiser's campaigns improve through the client's use of the process embodying USrevue. The quality score has a value within the range of zero to one hundred as well.

The cost benchmark is a MPMA norm for the whole market and is set at zero. Note that the whole market in the system is taken as being all the data, in this case costings data, for all the campaigns, and cost data obtained through assessing those campaigns, that the system has yet encountered. Therefore, the cost benchmark should change over time as UStimetraker is used over time. As a costing premium is expressed relative to the cost benchmark as a discount from the cost benchmark, the costing premium will be geared around zero. Therefore, the cost premium 103 for the campaign is a value expressed as a percentage point discount, or premium relative to the cost benchmark.

In FIG. 12, the cost premium 103 is shown in the bottom scale 111, and the quality score 69 is shown in a top scale 113. The scales on the top and bottom of the rack 109 show the range of scores and premiums achieved by use prior use of USrevue and Ustimetraker, i.e. MPMA clients. FIG. 12 shows three example racks for different campaigns. In the those diagrams the range for the quality score is from 72 to 90 inclusive. Similarly, the bottom scale 111 for the cost premium has a range from −8 to 10 inclusive.

Three values are indicated on the rack by three markers. One marker, which is labelled ‘Norms’ 115, indicates the value of the quality benchmark (the average quality score for the whole market) and the cost benchmark (the average cost premium for the whole market). An upper marker 117 indicates the quality score 69 for the campaign, whilst a lower marker 119 indicates the cost premium 103 for the campaign. Thus, the effectiveness of the campaign in terms of cost of the campaign and the quality of the campaign can be assessed visually by the client, relative to the average cost and average quality of the whole market.

Where the upper marker 117 and the lower marker 119 are shown opposite each other on the rack 109, the rack indicates an equitable performance, as shown in FIG. 12 (i). Where the upper marker 117 is to the right hand side of the rack 109 and the lower marker 119 is to the left hand side of the rack, the rack 109 indicates an excellent performance for the campaign as shown in FIG. 12 (ii). However, where the rack 109 shows the upper marker 117 is to the left hand side of the rack 109 and the lower marker 119 is to the right hand side of the rack 109, the rack indicates a poor performance of the campaign, as shown in FIG. 12 (iii). These relative assessments can be made between the upper and the lower markers 117, 119, or between the upper and lower markers 117, 119 and the ‘Norms’ marker 115, in order to assess the performance of the campaign relative to the competitive set, or market as a whole. Ultimately, the choice of the various parameters selected by the client in the first step 51 of the quality sub-system 33 determines the meaningfulness and usefulness of the rack as a tool to the client.

Modifications

The metrics used in USrevue can be amended and designed to meet a client's specific needs. In such a modification, the metrics used need not be included in the nine mentioned in the specific description, and the advertiser can elect not to use the standard metrics. The client can elect to use as many, or as few, metrics as he chooses.

Further, it is intended that the metrics shall develop over time to meet the client's needs.

In a modification to the third step 55, the first processing unit 11 validates the data files to ensure they exist after the data files are received by the first processing unit.

The error message referred to in the third step 55 can also be in the form of a sound.

The weighted average calculation in the sixth step 65 can be replaced by a simple average calculation.

The quality score and the cost premium can be evaluated for particular groups or sectors of competitors from the whole market instead of for the whole market. Thereby, the campaign is compared to particular competitors and not the whole market, focusing the assessment on, for example, a particular market sector or the competitors having adverts in a particular daypart.

The comparator 101 can be modified to use other factors, chosen at the advertiser's discretion. Also, where the Netcosts data is unreliable, for example at times where it is estimated, the user can use its own modelled costings data for the Ustimetraker, until the Netcosts data is once again provided from actual market data. Further, weighting can be applied to the discounting process where bulk purchases are made, as bigger purchases tend to be cheaper per unit value.

1. Apparatus for assessing the cost effectiveness of an advertising campaign, the apparatus comprising:
a) an input for receiving
i) a first set of data from at least one first data source; and
ii) a second set of data from at least one second data source;
b) an output; and
c) a processor arranged to:
i) aggregate and analyse the first set of data using at least one metric in order to provide output data, each of said at least one metric assessing a different characteristic of the first set of data;
ii) calculate a quality score according to a first scoring algorithm applied to the output data;
iii) calculate a cost premium from the second set of data according to a second scoring algorithm; and
iv) transmit to the output a graphical and quantitative comparison of the cost premium and the quality score, the cost premium being relative to a cost benchmark and the quality score being relative to a quality benchmark.

2. Apparatus as claimed in claim 1, wherein:
a) the input is arranged for receiving a third set of data, the third set of data concerning the at least one competitor advertising campaign during the advertising campaign starting on a campaign start date and ending on a campaign end date, the third set of data comprising information concerning the same features as the first data;
b) the processor is arranged to aggregate and analyse the third set of data, with the first set of data, using at least one metric in order to provide at least one output result, each at least one metric assessing a different characteristic of the third set of data and the first set of data; and
c) the first scoring algorithm comprises a scoring function, the scoring function being a routine that awards a quality score to the campaign.

3. Apparatus as claimed in claimed 1, wherein:
a) the input is arranged for receiving a fourth set of data, the fourth set of data concerning the at least one competitor advertising campaign for a duration of the advertising campaign having a campaign start date and a campaign end date, the fourth set of data comprising information concerning the same features as the second set of data; and
b) the second algorithm comprises a comparative function, the second comparative function comparing the second set of data with the fourth set of data.

4. Apparatus as claimed in claim 1, wherein each transmission of an advertisement on a venue is a spot, and said first set of data comprises data about each spot including spot data; a spot time; and a spot duration.

5. Apparatus as claimed as claim 1, wherein the first set of data comprises data about the campaign including: a campaign start date and a campaign end date.

6. Apparatus as claimed as in claim 1, wherein the first set of data comprises data relating to planned ratings for the advertising campaign.

7. Apparatus as claimed as in claim 1, wherein the first set of data comprises data relating to calculated ratings for each program transmitted on a venue.

8. Apparatus as claimed as in claim 1, wherein the second set of data comprises a costings information set for each venue.

9. Apparatus as claimed in claim 8, wherein the costings information set comprises information for each program transmitted on each venue.

10. Apparatus claimed as in claim 1, wherein the first set of data comprises data relating to program ratings for each program transmitted on a venue, where said processor operates to match each calculated program rating with a corresponding costing information set.

11. Apparatus as claimed in claim 10, wherein the first set of data comprises dates relating to program ratings for each program and on a venue, where said apparatus is configured to allow an operator to match manually each calculated program rating with a corresponding information set.

12. Apparatus claimed as in any of claims 1, 2 or 3, wherein said apparatus further comprises an output database, said processor transmitting said output data, said quality score and said cost premium to said output database for storage.

13. A method for assessing the cost effectiveness of an advertising campaign, the method comprising the steps of:
a) receiving a first set of data from at least one first data source;
b) processing the first set of data to provide output data by aggregating and analysing the data by means of at least one metric, said at least one metric assessing a different characteristic of the first set of data;
c) processing the output data according to a first scoring algorithm to calculate a quality score;
d) receiving a second set of data from at least one second data source;
e) processing the second set of data according to a second scoring algorithm to calculate a cost premium; and
f) graphically outputting an image showing a quantitative comparison of the cost premium and the quality score, the cost premium being relative to a cost benchmark, and the quality score being relative to a quality benchmark.

14. A method as claimed in claim 13, wherein said advertising campaign is publicised by means of TV advertisements.

15. A method as claimed as in claim 13, wherein said at least one metric considers the daypart of each spot.

16. A method as claimed in claim 13, wherein said at least one metric considers the venue of each spot.

17. A method claimed as in claim 16, wherein said venue is a network TV station and said at least one metric considers the distributor on which each spot is transmitted.

18. A method claimed as in claim 13, wherein said at least one metric considers the calculated rating of each spot.

19. A method claimed as in claim 18, wherein said at least one metric also considers the planned rating for the advertising campaign.

20. A method claimed as in claim 13, wherein said at least one metric considers the location of each spot in a POD.
